(19) United States
(12) Patent Application Publication
(10) Pub. No.: US 2026/0012876 A1
(43) Pub. Date: Jan. 8, 2026

(54) METHOD FOR COMMUNICATING BETWEEN TWO MICRO-NETS

(71) Applicant: SIEMENS AKTIENGESELLSCHAFT, München (DE)

(72) Inventor: Vincenzo Fiorentino, Nürnberg (DE)

(21) Appl. No.: 19/122,651

(22) PCT Filed: Oct. 5, 2023
(86) PCT No.: PCT/EP2023/077560

§ 371 Date: Apr. 18, 2025

(30) Foreign Application Priority Data
Oct. 20, 2022 (EP) 22202760.9

(51) Int. Cl. H04W 40/02; H04W 84/10; H04W 92/02

(52) U.S. Cl. CPC H04W 40/02; H04W 84/10; H04W 92/02

(57) ABSTRACT

A method of communicating with a first user equipment of a first micro-net. The method includes receives one or more packets from the second user equipment associated with the second micro-net and transmitting the one or more packets to a first user plane function of the first micro-net, wherein the first user plane function is configured to transmit the one or more packets to the first user equipment of the first micro net based on the destination information of the one or more packets. The second user plane function is connected to the first user plane function via a first pair of first dedicated user equipment and first radio unit and a second pair of second dedicated user equipment and second radio unit.

### CROSS REFERENCE TO RELATED APPLICATIONS

The present patent document is a § 371 nationalization of PCT Application Serial Number PCT/EP2023/077560, filed Oct. 5, 2023, designating the United States which is hereby incorporated in its entirety by reference. This patent document also claims the benefit of EP22202760.9 filed on Oct. 20, 2022, which is hereby incorporated in its entirety by reference.

### FIELD

Embodiments relate to wireless communication networks in industrial automation environments including substation automation and process automation, and to network functions of the wireless communication networks.

### BACKGROUND

With the advent of 4G EPC and 5G communication technology, most cellular networks include a central network core that includes a plurality of software based network functions that regulate and manage various aspects of the wireless communication network. Additionally, such networks may include micro-nets for enabling faster communication.

### BRIEF SUMMARY AND DESCRIPTION

The scope of the embodiments is defined solely by the appended claims and is not affected to any degree by the statements within this summary. The present embodiments may obviate one or more of the drawbacks or limitations in the related art. Independent of the grammatical term usage, individuals with male, female or other gender identities are included within the term. The current disclosure relates to wireless communication networks in industrial facilities and industrial automation environments. Wireless communication networks deployed in such facilities often need to such mission critical applications like fault location and service restoration, etc., and accordingly must guarantee ultra-low latency communication. This may be difficult or challenging since radio units of the distributed base stations are often present in locations several kilometers away from the central unit of the distributed base station and the central network core of the wireless communication network. Communication between end devices present in different locations often require a communication loop including the central network core. For example, for a user device for communicating to another user device, both the user devices must undergo the authentication procedure. Conventionally, the first user device (responsible for sending a message to the second user device), starts the authentication procedure and once the first user device is authenticated, a data message is sent from the first user device to the second user device via the network core. Then, the network core will page the second user device and starts the authentication also on the terminating side. Subsequent to the authentication of second user device, the message is passed to the second user device. Accordingly, such communication may suffer from significant end to end latency. For example, average latency for the registration is usually about 168 ms, that does not meet the latency requirements of the mission critical use cases (often about 10 ms).

One approach to address such issues is by the use of micro-nets. Micro-networks may operate and communicate to each other independently from the central core network, by replicating parts of the network functions present at the central core, at the distributed unit present in the corresponding micro-net. Conventionally, each micro-net is connected other micro-nets via wired network, for communicating to other micro-nets. However, such wired network deployment, especially in remote locations or off-shore, is often expensive and time consuming. Accordingly, there is a need for a flexible method for enabling communication amongst the micro-nets.

Accordingly, embodiments provide a method of communicating with a first user equipment of a first micro-net. The method is implemented by user plane function of a second micro-net. The method includes receiving one or more packets from the second user equipment associated with the second micro-net, wherein the one or more packets include a destination information associated with the first user equipment of the first micro-net; and transmitting the one or more packets to a first user plane function of the first micro-net, wherein the first user plane function is configured to transmit the one or more packets to the first user equipment of the first micro-net based on the destination information of the one or more packets. The second user plane function is communicatively connected to the first user plane function via a first pair of first dedicated user equipment and first radio unit and a second pair of second dedicated user equipment and second radio unit. The one or more packets are transmitted from the second user plane function to the first user plane function via the second dedicated user equipment from the second pair of second dedicated user equipment and second radio unit and the first radio unit from the first pair of first dedicated user equipment and first radio unit.

Embodiments further provide a method in which connection between two micro-nets is established using two pairs of dedicated user equipment and radio units. Embodiments provide a point to point radio link to interconnect two micro-nets by re-using part of the network equipment like Radio Units (RU) and User Equipment (UE) MIMO layers. Using the dedicated user equipment(s) and the radio units, a wireless connection may be provided between the micro-nets. Moreover, using the dedicated user equipment, each micro-net is abstracted from the other micro-net and therefore allowing for deployment of the current solution without significant efforts in relation to configuration. Moreover, this further creates a redundant radio link that increases the reliability of the whole radio network.

In an embodiment, the dedicated first user equipment is dedicated to the second user plane function and is for transmitting data from the first user plane function and wherein the dedicated second user equipment is dedicated to the first user plane function and is for transmitting data from the second user plane function. In an embodiment, the second radio unit is dedicated to the second user plane function and is for receiving data from the first user plane function and wherein the first radio unit is dedicated to the first user plane function and is for receiving data from the second user plane function. Accordingly, by having dedicated user equipment and radio units, a proper communication channel is established between the first and second micro-nets.

In an embodiment, the dedicated first user equipment is registered with the first micro-net and wherein the dedicated second user equipment is registered with the second micro-net. Accordingly, the first dedicated user equipment abstracts the second micro net from the first user plane functions and wherein the second dedicated user equipment abstracts the first micro net from the second user plane function. This provides for easy deployment of the provided solution in existing networks without requiring significant configuration.

In another aspect, the current disclosure describes a network device for communicating with a first user equipment of a first micro-net. The network device includes a first network interface connected to a second user equipment of a second micro-net, a second network interface connected to at least one of a of second radio unit and a dedicated first user equipment; and one or more processors connected to a memory module. The one or more processors are configured to receive one or more packets from the second user equipment associated with the second micro-net via the first network interface, wherein the one or more packets include a destination information associated with the first user equipment of the first micro-net; and transmit the one or more packets to a first user plane function of the first micro-net via the dedicated first user equipment, wherein the first user plane function is configured to transmit the one or more packets to the first user equipment of the first micro net based on the destination information of the one or more packets. In another aspect a non-transitory storage medium is provided. The non-transitory storage medium includes a plurality of instructions, that when executed on one or more processors, cause the one or more processors to receive one or more packets from a second user equipment associated with the second micro-net via a first network interface, wherein the one or more packets include a destination information associated with a first user equipment of a first micro-net; and transmit the one or more packets to a first user plane function of the first micro-net via a dedicated first user equipment, wherein the first user plane function is configured to transmit the one or more packets to the first user equipment of the first micro net based on the destination information of the one or more packets.

### BRIEF DESCRIPTION OF THE FIGURES

FIG. 1 depicts an example section of a wireless communication network in an industrial facility including two micro-nets according to an embodiment.

FIG. 2 depicts a method of communicating with a first user equipment of a first micro-net by a user plane function of a second micro-net according to an embodiment.

FIG. 3 depicts an example network device for communicating with a first user equipment of a first micro-net according to an embodiment.

FIG. 4 depicts an architecture and the interconnections of between micro-nets and/or network core according to an embodiment.

FIG. 5 depicts a 5G 3GPP reference architecture according to an embodiment.

FIG. 6 depicts the further details of the interconnections between micro-nets and/or a network core according to an embodiment.

FIG. 7 depicts a radio link to interconnect a first and a second micro-net according to an embodiment.

FIG. 8 depicts a redundant radio link through a third micro-net according to an embodiment.

FIG. 9 depicts a multicasting of packets to different micro-nets according to an embodiment.

FIG. 10 depicts a, e.g., point to point, radio link to interconnect more micro-nets according to an embodiment.

FIG. 11 depicts details of a UE for implementing TX/RX chains and L2/L3 functions, e.g., for setting up redundant transmission paths according to an embodiment.

FIG. 12 depicts details of a distributed base station for implementing TX/RX chains and L2/L3 functions, e.g., for receiving packets from a (dedicated) UE connected to another micro-net according to an embodiment.

### DETAILED DESCRIPTION

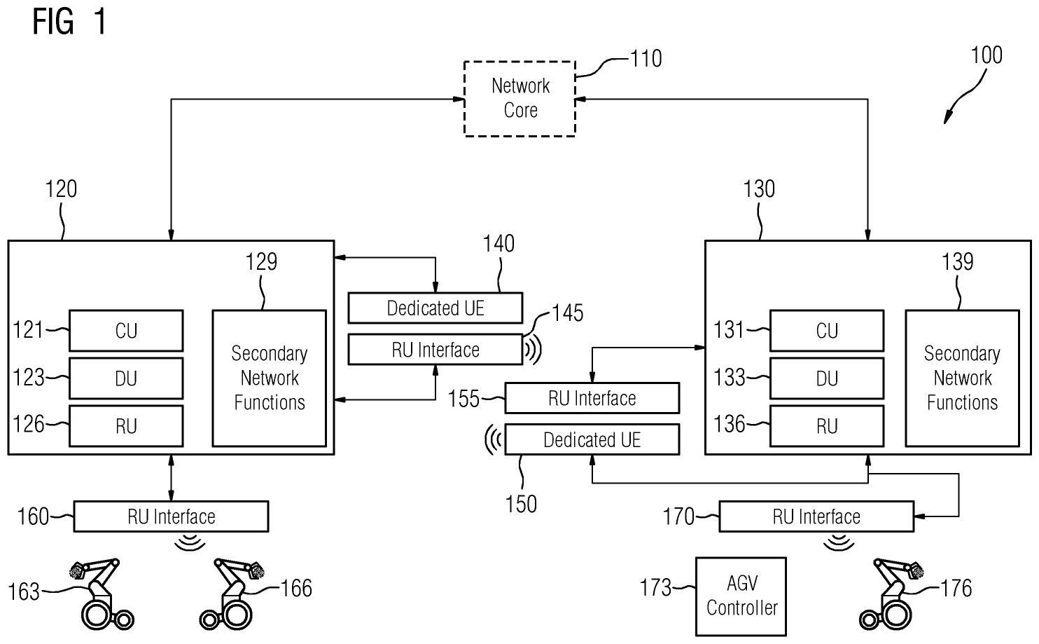

FIG. 1 depicts a section 100 of the wireless communication network in an industrial facility for connecting a plurality of industrial devices with each other. Industrial facility herein refers to any environment where one or more industrial processes such as manufacturing, refining, smelting, or assembly of equipment, generation, transmission or distribution of electricity, and transportation, may take place. This includes process plants, oil refineries, automobile factories, power plants, smart grids, electrical substations, storehouses, etc. The plurality of industrial process and operations may be carried out in production cells using a plurality of devices such as control devices, field devices, mobile devices, etc., present with the corresponding production cell. The control devices include process controllers, programmable logic controllers, supervisory controllers, automated guided vehicles, robots, operator devices, etc. One or more control devices are connected to a plurality of field devices (not shown in figure) such as actuators and sensor devices for monitoring and controlling various industrial processes in the industrial facility. These field devices may include flowmeters, value actuators, temperature sensors, pressure sensors, etc. Additionally, the industrial facility includes a plurality of mobile devices (also referred to as mobile network devices) including one or more robots for performing a plurality of operations such as welding, assembly of parts; one or more autonomous guided vehicles for transportation and handling of material; one or more assets with RFID tags on conveyor belts, etc. in the industrial facility. Additionally, the industrial facility may include an operator station for displaying the status of the industrial facility to an operator and for allowing the operator to define KPIs for the control of the industrial processes in the facility. All the industrial devices may be connected to each other via a plant network (realized via wired and wireless technologies).

Communication in the above-mentioned plant network happens through wired and wireless technologies. Accordingly, the industrial facility utilizes the wireless communication network for enabling communication amongst the various devices of the industrial facility. The wireless communication network is based on cellular technology and includes a plurality of gateway devices or network devices. Gateway devices herein refers to one or more devices capable of connecting the user devices to the wireless network. Examples of gateway devices include base stations, routers, switches, relays, access points, etc. The plurality of gateway devices may include stationary gateway devices that may be affixed to a plurality of locations in the industrial facility. A plurality of the industrial devices in the facility are connected to one or more gateway devices to connect to the wireless network and for communicating information with the other devices and systems in the industrial facility. The industrial devices include one or more industrial applications that are capable of processing data from other industrial devices.

The wireless communication network includes a network core 110 that includes a plurality of network functions such as user plane function (UPF), authentication server function (AUSF), access and mobility function (AMF), session management function (SMF), network exposure function (NEF) etc. Network function herein refers to software module responsible for realizing and managing as certain network aspect in relation to the wireless communication network. For the AUSF provides an authentication service for the devices connected to the wireless communication network. Similarly, the UPF User plane function (UPF) supports packet routing & forwarding, packet inspection, QoS handling, etc. Network functions and their related functions are known in the state of the art and have a similar meaning as conventionally known. Network function herein refers to software module or executable code responsible for realizing and managing as certain network aspect in relation to the wireless communication network. In 5G, the network functions are software modules separate from the hardware and may be executed on any network node. Each virtual function may be deployed on separate machine or even in cloud. Network functions and their related functions are known in the state of the art and have a similar meaning as conventionally known. For the AUSF provides an authentication service for the devices connected to the wireless communication network. Similarly, the UPF User plane function (UPF) supports packet routing & forwarding, packet inspection, QoS handling, etc. Similarly, the Unified Data Management (UDM) network function is responsible for generation of credentials, user identification, access authorization, and subscription management. Similarly, the Access and Mobility Function (AMF) is responsible for manages connection and mobility and includes a Globally Unique AMF Identifier (GUAMI) that is used to identify an AMF Instance within a 5G Network.

The network core 110 is connected to a plurality of micro-nets (120 and 130). Each micro-net includes at least one distributed base station including a radio unit (126, 136), a distributed unit (123, 133) and a central unit (121, 131). The distributed base station may be regarded as a gateway device. The radio unit (126,136) is connected to a plurality of radio sub-units or interfaces (shown as radio sub-units 160 and 145, and radio sub-units 150 and 136). The conventional functions/responsibilities of the central unit, and the distributed unit depends on the Split Option utilized in the implementation of the distributed base station. The industrial devices (163 and 166, and 173 and 176) are connected to the wireless communication network using the distributed base stations.

Additionally, each micro-net includes one or more secondary network functions (129 and 139) that are capable of coordinating with the network functions of the network core 110 for managing the industrial devices connected to the corresponding micro-net. The one or more secondary network functions (129 and 139) are similar to or correspond to the one or more network functions of the network core. The one or more secondary network functions are associated with admission control and authentication of the industrial devices, management of user plane and sessions related to connections associated with the industrial devices in the corresponding micro-net.

The one or more network functions of the network core are configured to forward network configurations and control information associated with one or more user devices connected to a micro-net, to the one or more corresponding secondary network functions of the micro-net. Based on the received network configurations and control information associated with one or more user devices, the one or more secondary network functions are configured to manage the user devices of the micro-net. The secondary network functions are installed in a network device associated with the corresponding micro-net as software modules and manage the control plane and/or the user plane of the corresponding micro-net.

In an example, the one or more secondary network functions includes one or more of the following a network exposure function (NEF), a session management function (SMF), authentication server function (AUSF), unified data management function (UDM), user plane function (UPF), etc. The network exposure function from the one or more secondary functions acts as an interface between the network functions of the network core and the other secondary network functions, is used to configure the local core functions and report local information to the network core. Similarly, a specialized application network function (AF) is implemented in the network core to coordinate with the one or more secondary network functions. For example, for establishing a PDU session between the micro-net and the user plane function of the network core, the coordination between the local SMF of the one or more secondary network functions and the SMF of the network core happens via the local NEF of the one or more secondary network functions and the application function. Additionally, the application network function is responsible for transferring user information, security information and network configuration and policies between the network core and the one or more secondary network functions. The application network function also retrieves performance and maintenance data from the one or more secondary network functions.

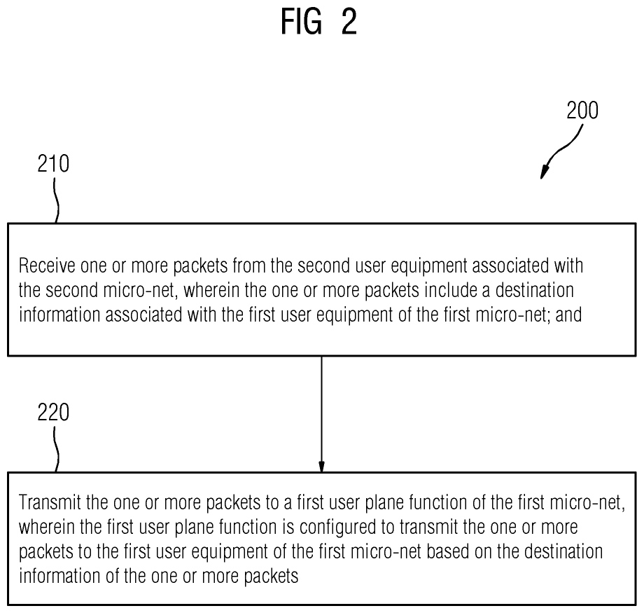

Additionally, to enable communication between the micro-nets without utilizing the network core 110, each micro-net includes a dedicated user equipment and a dedicated radio interface. For example, as shown in FIG. 1, the micro-net 120 includes a dedicated user equipment 140 and a dedicated radio interface 145. Similarly, the micro-net 130 includes a dedicated user equipment 150 and a dedicated radio interface 155. The dedicated radio interfaces are connected to the corresponding radio unit of the corresponding micro-net and are providing radio coverage to a dedicated user equipment associated with the other micro-net. Specifically, the dedicated radio interfaces may be RX/TX chain of the corresponding radio units, dedicated to communicate to the dedicated User Equipment connected to another Micro-net. Using the pairs of dedicated radio interfaces and user equipment, the micro-nets are capable of communicating with each other. This is further explained in reference to FIG. 2.

FIG. 2 depicts a method 200 of communicating with a first user equipment 163 of a first micro-net 120. In an example, the method 200 is realized by user plane function of a second micro-net 130. In an example, the first user equipment 163 is located on an automated guidance vehicle or a robot.

At step 210, the user plane function (one of the secondary network functions 139) receives one or more packets from the second user equipment (for providing wireless connectivity to an AGV controller 173) associated with the second micro-net 130. The one or more packets include a destination information associated with the first user equipment 163 of the first micro-net 120.

For example, the AGV controller 173 in the second micro-net is responsible for communicating with the automated guidance vehicle 163 in the first micro-net, controlling the automated guidance vehicle 163. Accordingly, the one or more packets from the AGV controller 173 may include route and task information associated with the automated guidance vehicle 163. Accordingly, to communicate with the automated guidance vehicle 163, the AGV controller transmits packets to the second user plane function of the second micro-net via the radio interface 170 (that in turn is connected to the distributed base station containing the radio unit 136, distributed unit 133 and the central unit 131, connected to the second user plane function).

Since the packets from the AGV controller 173 contain the address of the AGV 163 as the destination address, the second user plane function determines that the AGV 163 is connected to the first micro-net and accordingly, proceeds to connect to the first micro-net to transmit the packets.

At step 220, the second user plane function transmits the one or more packets to a first user plane function (of the secondary network functions 129) of the first micro-net 120, wherein the first user plane function is configured to transmit the one or more packets to the first user equipment 163 of the first micro net 120 based on the destination information of the one or more packets.

The second user plane function is communicatively connected to the first user plane function via a first pair of first dedicated user equipment 140 and first radio unit 145 and a second pair of second dedicated user equipment 150 and second radio unit 155. The dedicated user equipment and dedicated radio interfaces act as a dedicated channel between the first and second micro-nets and ensure connectivity between them. The dedicated user equipment are used for transmitting data from the corresponding micro-net (i.e. the micro-net to which they are dedicated to) to the other micro-net. Similarly, the dedicated radio interfaces are coupled to the corresponding micro-nets for receiving data from the associated user equipment. Accordingly, each radio interface is associated with a corresponding user equipment (for reception and transmission respectively). For example, as shown in the figure, the dedicated user interface 140 is dedicated to the micro-net 120, and the dedicated user equipment 150 is dedicated to the micro-net 130. Similarly, the radio unit interface 145 is dedicated to the micro-net 120 and the radio unit interface 155 is dedicated to the micro-net 130. Additionally, the dedicated user equipment 140 is coupled to the radio unit interface 155 (for transmission and reception respectively) and similarly, the dedicated user interface 150 is coupled to the radio unit interface 145 (for transmission and reception respectively). Accordingly, the one or more packets are transmitted from the second user plane function to the first user plane function via the second dedicated user equipment 150 to the first radio unit 145.

Accordingly, one or more connections between the micro-nets are provided by using the dedicated user equipment and the radio unit interfaces, without including the network core.

In an example, the dedicated user equipment 150 is registered with the first user plane function and wherein the dedicated user equipment 140 is registered with the second user plane function. Registration herein refers that the dedicated user equipment is a subscriber of the micro-net and/or when switched on, the dedicated user equipment is registered with the network functions of the corresponding micro-net and is managed by the registered micro-net. Accordingly, the micro-net (to which the dedicated user equipment is registered) treats the dedicated user equipment similar to the other user equipment despite the user equipment being located in the physical region of the other micro-net and connected to its user plane function.

Accordingly, the first dedicated user equipment 140 abstracts the second micro net 130 from the first user plane function of the first micro-net 120. Similarly, the second dedicated user equipment 150 abstracts the first micro net 120 from the second user plane function of the second micro-net 130.

In addition to allowing for communication between micro-nets, the above mentioned network infrastructure may be utilized in improving redundancy and reliability in network communications. For example, when three or more micro-nets are interconnected using the dedicated pairs of user equipment and radio unit interfaces, two network paths exist between each micro-net and the other micro-net (a direct connection and an indirect connection via the third micro-net). For example, when there are three micro-nets (A, B, C), and each of them are interconnected, there exists two network paths between micro-net A and B (a direct connection between A and B, and an indirect connection via micro-net C). Accordingly, using such interconnected micro-nets, packets may be broadcast over the multiple network paths.

For example, the dedicated user equipment and radio unit interfaces may be equipped with duplication and de-duplication modules, for implementing packet redundancy protocols such as parallel redundancy protocol (PRP). Such modules may be implemented in link layer of the dedicated user equipment and the radio unit interfaces. For example, a user equipment in a micro-net A, may intend to transmit packets to a user equipment in micro-net B. Accordingly, the dedicated user equipment associated with the micro-net A duplicates the packets and sends a first set of packets to the radio unit interfaces associated with micro-net B and micro-net C. The radio interface unit of the micro-net C forwards the packets to the user plane function of the micro-net C that utilizes the dedicated user equipment associated with the micro-net C to forward the packets to the radio unit interface of the micro-net B. Accordingly, the radio interface associated with the micro-net B receives two copies of the packets (one from micro-net A and one from micro-net C). Then, the radio unit interface of the micro-net C eliminates one of the copies and forwards one copy to the user plane function of the micro-net C, that sends it to the intended user equipment in micro-net C. In case the direct link (A-B) fails for any reasons the communication will be maintained over the link A-C-B, although extra latency will be introduced.

Accordingly, redundancy and reliability is improved in the network infrastructure by using the connections between the micro-nets. Additionally, such connections may be used in broadcast and multicast communications as known to a person skilled in the art.

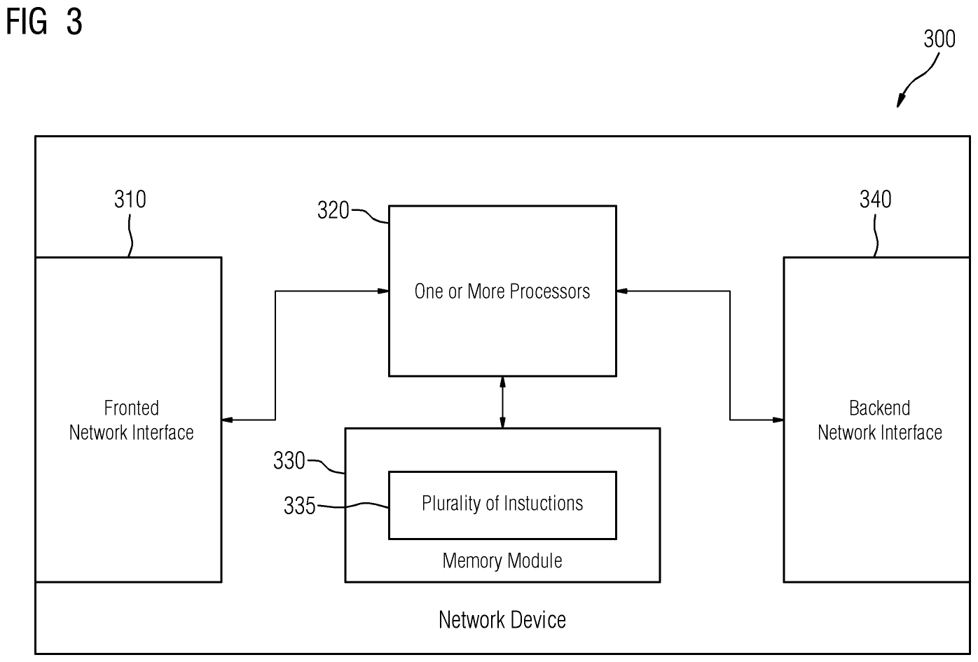

While the embodiments have been described in relation to a single network device with one or more secondary network functions, a plurality of such network devices may be used in the industrial facility. Accordingly, such network devices with their micro-networks may communicate with each other without looping the central network core. This is further explained in relation to FIG. 3.

Accordingly, embodiments describes a network device 300 for communicating with a first user equipment of a first micro-net. The network device 300 includes a first network interface 310 connected to a second user equipment of a second micro-net, and a second network interface 340 connected to at least one of a of second radio unit and a dedicated first user equipment. The network device 300 further includes one or more processors 320 connected to a memory module 330. The memory module 330 includes a plurality of instructions 335, that when executed, cause the one or more processors 330 configured to receive one or more packets from the second user equipment associated with the second micro-net via the first network interface 310, wherein the one or more packets include a destination information associated with the first user equipment of the first micro-net; and transmit the one or more packets to a first user plane function of the first micro-net via the dedicated first user equipment, wherein the first user plane function is configured to transmit the one or more packets to the first user equipment of the first micro net based on the destination information of the one or more packets.

For the purpose of this description, a computer-usable or computer-readable non-transitory storage medium may be any apparatus that may contain, store, communicate, propagate, or transport the program for use by or in connection with the instruction execution system, apparatus, or device. The medium may be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processing units and program code for implementing each aspect of the technology may be centralized or distributed (or a combination thereof) as known to those skilled in the art.

In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope. All advantageous embodiments claimed in method claims may also be applied to device/non transitory storage medium claims.

Further embodiments are provided in the following: According to a first embodiment, a method of communicating with a first user equipment of a first micro-net, is provided, the method, by, e.g., a second, user plane function of a second micro-net, including: receiving one or more packets from the second user equipment associated with the second micro-net, wherein the one or more packets include a destination information associated with the first user equipment of the first micro-net; and transmitting the one or more packets to a first user plane function of the first micro-net, wherein the first user plane function is configured to transmit the one or more packets to the first user equipment of the first micro net based on the destination information of the one or more packets; wherein the second user plane function is communicatively connected to the first user plane function via, e.g., the air between, a first pair of first dedicated user equipment and first radio unit and a second pair of second dedicated user equipment and second radio unit, and wherein the one or more packets are transmitted from the second user plane function to the first user plane function via the second dedicated user equipment from the second pair of second dedicated user equipment and second radio unit and the first radio unit from the first pair of first dedicated user equipment and first radio unit.

A method of communicating with a first user equipment of a first micro-net, is provided, the method, by a second user plane function of a second micro-net. The method including: receiving one or more packets from the second user equipment associated with the second micro-net, wherein the one or more packets include a destination information associated with the first user equipment of the first micro-net; and transmitting the one or more packets to a first user plane function of the first micro-net, wherein the first user plane function is configured to transmit the one or more packets to the first user equipment of the first micro net based on the destination information of the one or more packet. Therein, the second user plane function is communicatively connected to the first user plane function via a second dedicated UE and a first RU. Therein, the one or more packets are transmitted from the second user plane function to the first user plane function via the second dedicated user equipment and the RU.

In a second embodiment, the method as provided in the first embodiment, wherein the dedicated first user equipment is dedicated to the second user plane function and is for transmitting data to the first user plane function and wherein the dedicated second user equipment is dedicated to the first user plane function and is for transmitting data to the second user plane function.

In a third embodiment, the method as provided in the first embodiment, wherein the second radio unit is dedicated to the second user plane function and is for receiving data from the first user plane function and wherein the first radio unit is dedicated to the first user plane function and is for receiving data from the second user plane function.

In a fourth embodiment, the method as provided in the first embodiment, wherein the dedicated first user equipment is registered with the second user plane function and wherein the dedicated second user equipment is registered with the first user plane function.

In a fifth embodiment, the method as provided in the first embodiment, wherein the first dedicated user equipment abstracts the second micro net from the first user plane functions and wherein the second dedicated user equipment abstracts the first micro net from the second user plane function.

In a sixth embodiment, a network device for communicating with a first user equipment of a first micro-net, is provided, the network device including: a first network interface connected to a second user equipment of a second micro-net; a second network interface connected to at least one of a of second radio unit and a dedicated first user equipment; and one or more processors connected to a memory module, the one or more processors configured to: receive one or more packets from the second user equipment associated with the second micro-net via the first network interface, wherein the one or more packets include a destination information associated with the first user equipment of the first micro-net; and transmit the one or more packets to a first user plane function of the first micro-net via the dedicated first user equipment, wherein the first user plane function is configured to transmit the one or more packets to the first user equipment of the first micro net based on the destination information of the one or more packets.

A network device for communicating with a first user equipment of a first micro-net, is provided. The network device including a first network interface connected to a second user equipment of a second micro-net, and a second network interface connected to at least one of a of second radio unit and a dedicated first user equipment. Here it should be understood that the dedicated first UE corresponds to the dedicated second UE of the first embodiment. That is, the dedicated UE is associated with the first UPF, but nonetheless connected to the second UPF, as inter alia described herein.

In a seventh embodiment, a non-transitory storage medium is provided including a plurality of instructions, that when executed on one or more processors, cause the one or more processors to: receive one or more packets from a second user equipment associated with the second micro-net via a first network interface, wherein the one or more packets include a destination information associated with a first user equipment of a first micro-net; and transmit the one or more packets to a first user plane function of the first micro-net via a dedicated first user equipment, wherein the first user plane function is configured to transmit the one or more packets to the first user equipment of the first micro net based on the destination information of the one or more packets.

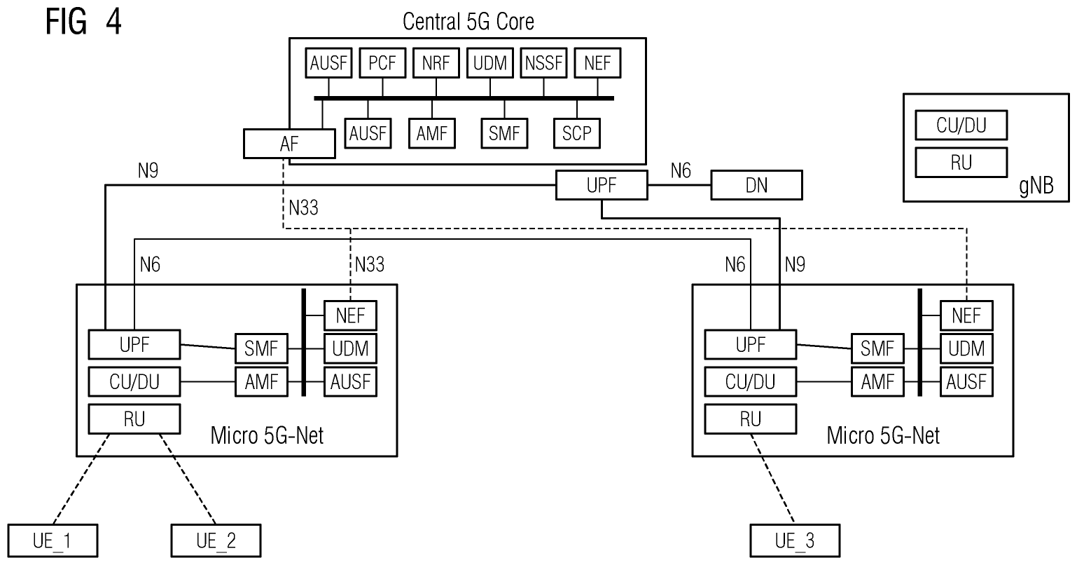

Turning to FIG. 4, a further embodiment is shown. A network core, denoted as Central 5G Core in FIG. 4, includes one or more network functions. The network core includes network functions such as connectivity and mobility management, authentication and authorization, and/or subscriber data management and/or policy management, among others as mentioned herein. Now, the user plane may be located close to RAN to reduce the latency when forwarding data to the relevant processing resources. In order achieve this and other advantages a Packet Flow Control Protocol (PFCP)—as specified in 3GPP TS 29.244—is provided. The PFCP is implemented in the component called the user plane function, UPF. The UPF may be connected to the control plane, e.g., the session management function, SMF, by a N4 interface. The UPF may be connected to one or more data networks, DN, via a N6 interface.

The application network function, AF, may provide user information, security information and/or network configuration, and/or policies between the network core and the one or more secondary network functions to the one or more distributed base stations, for example via a N33 interface connecting the AF to the one or more secondary network functions in one or more distributed base stations or micro-nets as shown FIG. 4. Hence, one or more local core functions may be present in a distributed base station, i.e., at the respective micro-net.

In addition or alternatively, a local UPF may be present in a distributed base station or micro-net. A UPF may be implemented according to 3GPP TS 23.501 (Release 15 onwards). The UPF includes the following functionality, wherein some or all of the UPF functionalities may be supported in a single instance of a UPF:

Anchor point for Intra-/Inter-RAT mobility (when applicable).

Allocation of UE IP address/prefix (if supported) in response to SMF request.

External PDU Session point of interconnect to Data Network.

Packet routing and forwarding (e.g., support of Uplink classifier to route traffic flows to an instance of a data network, support of Branching point to support multi-homed PDU Session, support of traffic forwarding within a 5G VN group (UPF local switching, via N6, via N19)).

Packet inspection (e.g., Application detection based on service data flow template and the optional PFDs received from the SMF in addition).

User Plane part of policy rule enforcement, e.g., Gating, Redirection, Traffic steering.

Lawful intercept (UP collection).

Traffic usage reporting.

QoS handling for user plane, e.g., UL/DL rate enforcement, Reflective QoS marking in DL.

Uplink Traffic verification (SDF to QoS Flow mapping).

Transport level packet marking in the uplink and downlink.

Downlink packet buffering and downlink data notification triggering.

Sending and forwarding of one or more “end markers” to the source NG-RAN node.

Packet duplication in downlink direction and elimination in uplink direction in GTP-U layer.

In general, a UPF enables packet processing and/or traffic aggregation to be performed close to the network edge or close to the distributed base stations, increasing bandwidth efficiencies while reducing network traffic.

As mentioned, and as shown in FIG. 4, each distributed base station or micro-net may include a local UPF. This decouples the distributed base station(s) and/or the respective micro-net(s). This decoupling essentially enables low latency for end-user data applications, i.e., for packet processing and/or traffic aggregation. The ability to process one or more data packets at the distributed base stations increases bandwidth efficiencies, enables low-latency applications, and reduces core network traffic.

The interface between two UPFs may be an N9 interface. As shown in FIG. 4, the local UPF in the first and second distributed base station or micro-net are connected via such an N9 interface to a central UPF. The local UPFs may be located in a distributed base station of the respective micro-net. Therein the central UPF may be a so called UPF Session Anchor(s) and the local UPF(s), may be so called Intermediate UPF, I-UPF. In any case, the local UPF(s) may be independent of the central UPF and/or there may be no central UPF present.

Furthermore, the local UPF of the first micro-net may be connected to the local UPF of the second micro-net via a N6 interface. This connection may be provided by a data network to which the local UPF of the first micro-net and the local UPF of the second micro-net are connected, e.g. again via a N6 interface.

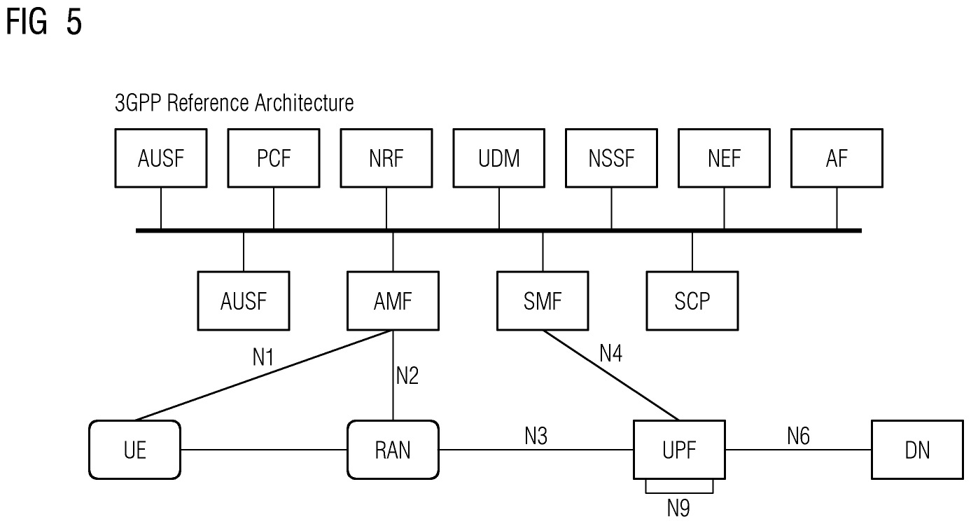

A 5G 3GPP reference architecture with same or similar components as described herein is provide in FIG. 5.

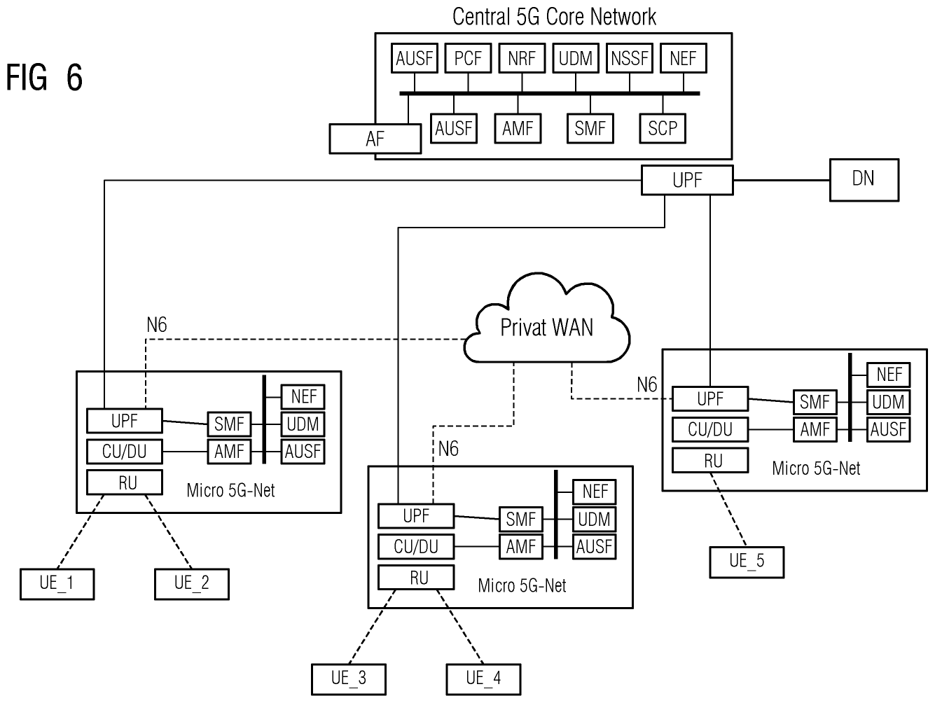

In FIG. 6, a plurality of micro-nets is shown that are interconnected via a private WAN. Therein, the UPF of a respective micro-net, e.g., located in a distributed bases station, is connected to the private WAN. User plane communication may take place among the micro-nets inside the private Wide Area Network, WAN. More 5G micro-nets may be connected via a private WAN. The private WAN may be a wired network or a point-to point radio link. It may also be based on WiMAX, e.g., by re-use of existing infrastructures. The private WAN may connect the micro-nets by the use of a radio link, e.g., based on 5G, as described herein. Hence, a communication path between UE_1 and UE_2 is closed inside the same distributed base station or gNB, including all control and data plane without reaching the network core. A communication between UE_1 and UE_5, connected to different distributed base stations, is routed through the private WAN via the local UPFs (and the control plane communication is managed inside the respective micro-nets, e.g., by the local network functions), for example without reaching the network core, and/or any other central or non-local functions or components. The communication over the private WAN and/or between the local UPF(s) may take place via the one or more N6 interface, e.g., according to the 3GPP standard, e.g., over a data network that serves as a private WAN to which the local UPF(s) is connected, for example via an N6 interface. The local UPF(s) may also communicate, e.g., via a N9 interface, with the central UPF.

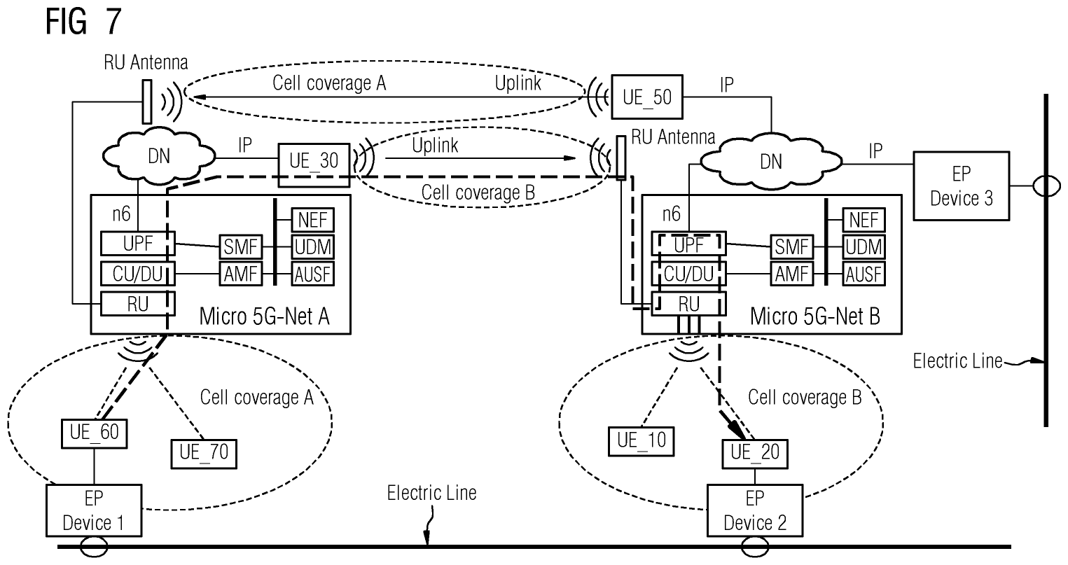

FIG. 7 depicts micro-nets, denoted as Micro 5G-Net A and Micro 5G-Net B in FIG. 7, where some (essential) core network functions are decentralized and/or decoupled form the network core. The setup is similar to the one described herein, e.g., in connection with FIG. 1.

A user equipment, such as UE_60, may be connected to a control device and/or to a field device, such as an actuator and/or a sensor device, e.g., EP device 1. In FIG. 7 a device, i.e., EP device 1, such as a circuit breaker, for controlling and/or monitoring of an electric line is shown. EP device 2 may be a similar device or a device of the same type, i.e., a circuit breaker, for controlling and/or monitoring of an electric line.

Now, the user equipment UE_60 associated with the micro-net Micro 5G-Net A may transmit one or more packets including a destination information associated with the first user equipment of the first micro-net. The packets may for example include measurement data from the device “EP device 1”.

The one or more packets are transmitted from the user equipment UE_60 to the local UPF of the micro-net Micro 5G-Net A, e.g. via RU and CU/DU of the micro-net Micro 5G-Net A.

From the local UPF of this second micro-net, the one or more packets are transmitted to the local UPF of the first Micro-net, Micro 5G-Net B. Hitherto, the one or more packets are transmitted via an N6 interface of the local UPF of the second micro-net to a data network DN. The data network is on the other hand connected to a dedicated UE, UE_30, that is associated to the first micro-net or distributed base station, Micro 5G-Net B. The connection between the data network and the dedicated UE, UE_30, may be provided via the Internet protocol, IP. That is the second dedicated UE, UE_30, is connected to the data network over the internet protocol, IP. The second dedicated UE, UE_30, transmits the one or more packets over the air to the first micro-net, i.e. Micro 5G-net B. There the one or more packets are received by an RU antenna. The packets are forwarded via the radio unit, the CU/DU and the UPF of the first micro-net to the UE_20, where they are received. It should be understood that, as shown in FIG. 7, the second dedicated UE UE_30 is associated with the first micro-net and within the cell coverage of the first micro-net in order for the second dedicated UE to transmit the packet in the uplink to the first micro-net, e.g., as described herein. The one or more packets received from the second dedicated UE, UE_30, by the RU of the first micro net or distributed base station are at first forwarded to the CU/DU and the local UPF of the first micro-net. The one or more packets are forwarded again to the CU/DU and the RU to be transmitted to/received by the first user equipment, UE_20, eventually via a different RU antenna of the first micro-net or distributed base station. The first UE, UE_20, is associated to the and/or within the cell coverage of the first micro-net, Micro 5G-Net B, e.g. as well as other the UEs, e.g., UE_10.

For transmission of one or more packets from the first UE, UE_20, to the second UE, UE_60, the second UE transmits one or more packets to the first dedicated UE, UE_50. To that end, the one or more packets are transmitted over the RU, CU/DU and UPF of the first micro-net, Micro 5G-Net B, via a N6 interface to a data network. From that data network the one or more data packets are transmitted via the internet protocol to the first dedicated UE. The first dedicated UE is associated with the second micro-net or distributed base station, Micro 5G-Net A. The first dedicated UE transmits the one or more data packets in the uplink to the second micro-net or distributed base station, Micro 5G-Net A, where it is received by an RU Antenna of the second micro-net or distributed base station, Micro 5G-Net A. From there the one or more data packets are transmitted over RU, CU/DU and local UPF of the second micro-net or distributed base station, Micro 5G-Net A, to the second UE, UE_60. The one or more data packets from the first UE, UE_20, are received and forwarded over the RU, CU/DU and UPF and again over the CU/DU and the RU, and eventually over a different antenna of the second micro-net or distributed base station, Micro 5G-Net A, to the second UE, UE_60.

As the case may be a device, such as EP device 3, may be connected to the data network, via the internet protocol, IP. Thus, one or more data packets may be transmitted and/or received from the device, EP device 3. In that case, the one or more data packets are transmitted from EP device 3 to the data network and forwarded to the first dedicated UE, UE_50, via the data network and again the internet protocol to the first dedicated UE, UE_50. The first dedicated UE, UE_50, then transmits, as before, the one or more data packets to the second micro-net or distributed base station, Micro 5G-Net A, e.g., to be received by the second UE, UE_60.

In order for the device, EP device 3, to receive one or more packets from the second UE, UE_60, the one or more packets are transmitted from the second UE, UE_60, to over the second micro net, i.e. RU, CU/DU and local UPF of the second micro-net, Micro 5G-Net A, and the second dedicated UE, UE30, to the first micro-net, Micro 5G-Net B, i.e. the local UPF of the first micro-net. From the local UPF od the first micro-net the one or more packets are forwarded to the data network via a n6 interface and from the data network to the device, EP device 3 via the internet protocol, IP.

The subscription (e.g. SIM) of second dedicated UE, UE_30, belongs to the first micro-net, Micro 5G-Net B, and/or it is under the coverage of the RU installed in the first micro-net, Micro-Net B. The RU in first micro-net, Micro 5G-Net B, dedicates one TX/RX chain or a MIMO layer. Similarly, the first dedicated UE, UE_50, subscription belongs to second micro-net, Micro 5G-Net A, and/or it is under coverage of the RU connected to the second micro-net, Micro-Net A.

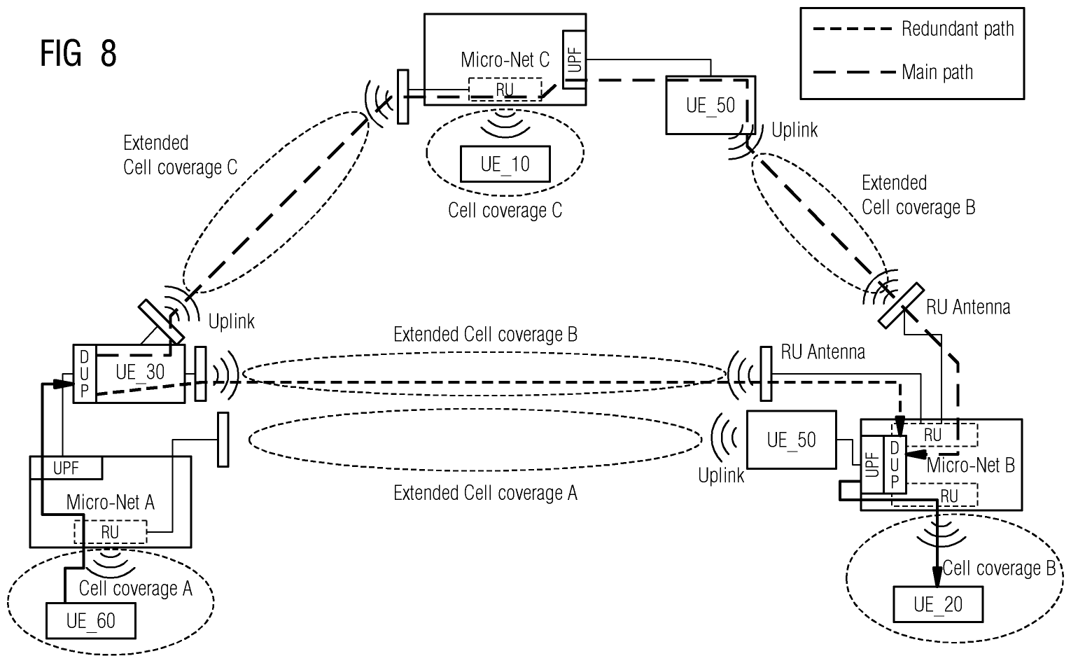

Turning to FIG. 8, the mechanism described herein, for example in connection with FIG. 7, may be applied to create a redundant radio link through a third micro-net, Micro-Net C. The different micro-nets are now referred to as Micro-Net A, B, and C, similarly to FIG. 7. In this case the dedicated UEs, UE_30 and the UE_50, and the two local UPFs of Micro-Nets A and B include or are connected to a frame duplication function that is referred to as “DUP”. For example, the DUP may be a Redundancy Handling Function (RHF) or the TSN FRER (Frame Replication and Elimination Reliability) or any other duplication-handling capable protocols.

In the example depicted in FIG. 8, the UE_60 sends a packet to the UE_20 via a direct path and a redundant path. The UE_60 and the UE_20 do not have any knowledge of the redundancy features implemented in the connectivity network. The UE_60 sends one or more packets to UE_20 via the first micro-net, i.e. Micro-Net A. The local UPF of Micro-Net A routes the information to UE_30 that includes or is coupled to a DUP function. This duplication function splits the one or more packets, e.g., of a data stream into a main path to the second micro-net, Micro-Net B, and a redundant path to the third micro-net, Micro-Net C. The second micro-net, Micro-net B, receives the signal via its RU, where it sis demodulated, and forwarded to the DUP of the local UPF of the second micro-net, Micro-Net B. The third micro-net, Micro-net C, the signal is received, sent to the local UPF of the third micro-net that in turn sends it to UE_50. The one or more packets from UE_50 are received, e.g., via another branch of the RU, at the second micro-net, of Micro-Net B, demodulated, and as well sent to the DUP of the local UPF of the second micro-net. The DUP of the local UPF of the second micro-net recombines the two received signals from both branches (i.e. packets received from UE_30 and UE_50) and sends the one or more packets, e.g., again as one data stream, to the destination UE_20 via the local UPF of the second micro-net. The local UPF of the second micro-net, Micro-Net B, thus routes the data stream to the UE_20.

If the main radio link, between the first and the second micro-net, i.e. between micro-nets Micro-Net A and Micro-Net B, goes down for any reason including a sudden increase in the interference that might compromise the reliability, the one or more packets are still sent through the third micro-net, Micro-Net C. This configuration may also be scaled up by adding more redundant paths, via additional micro-nets, to the destination micro-net to increase the level of reliability.

The third micro-net, micro-net C, may be the central core network that is connected remotely to the different micro-nets. In case the third micro-net, Micro-Net C, is a central core network, each periphery micro-net may be remotely synchronized to the central core, as described in the European patent application EP4152731 A1 herein incorporated by reference in its entirety, also via this 5G radio link solution. The subscriber information may be synchronized via the NEF that are transported over the 5G radio link.

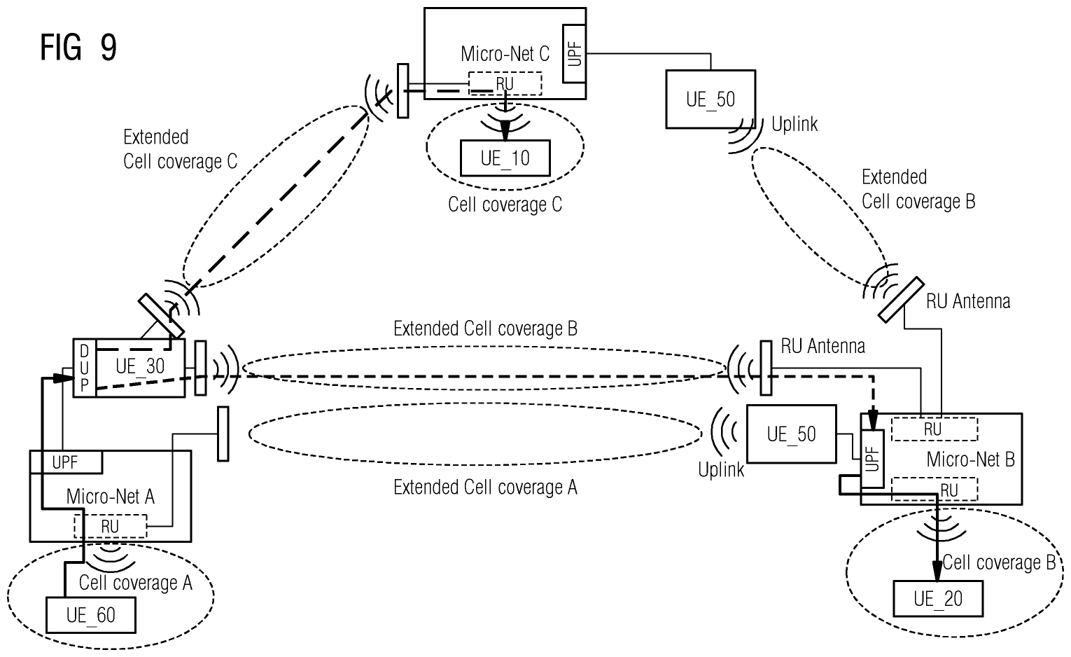

Turning to FIG. 9, a similar configuration as shown in FIG. 8, may be used to support a multicasting at network level, for example Goose protocol multicast, e.g., in electric power applications. Generic Substation Events (GSE) is a control model defined as per IEC 61850 that provides a fast and reliable mechanism of transferring event data over entire electrical substation networks. When implemented, this model ensures the same event message is received by multiple physical devices using multicast or broadcast services. The GSE control model is further subdivided into GOOSE (Generic Object Oriented Substation Events) and GSSE (Generic Substation State Events).

Goose messages, i.e. one or more packets, are used in electric power Substations that are also sent in multicast. A mobile network does not support a native broadcast/multicast function at network level, this is possible with an additional platform in the core network. This solution supports a multicast IP transmission at network level by connecting one micro-net to several other micro-Net and route a message from one UE to many UE located under the coverage of different micro-nets.

In FIG. 9 the DUP function does not have the task of duplicating frames for the same receiver, but to send the same message to different micro-nets, e.g., that correspond to different Sub-Stations according to GOOSE. An application, e.g., on a device, behind the UE_60 may flag one or more packets, e.g., one or more IP packets, in order to indicate to that the DUP function that it has to send the one or more packets to all a plurality of different receivers. The receiving local UPFs of the other micro-nets forward the one or more packets to all UEs currently under the coverage of the micro-net or to the destination (IP) addresses indicated in the original (IP) packet.

The use of one or more dedicated UEs to replicate the same one or more packets over multiple radio paths may also be used to create a point to multi point connection. This is typically applied in an electric power application where goose messages are multicasted.

The solutions described herein may be applied in factory automation where, e.g., each one of a plurality of halls, are covered by a micro-net and all micro-nets are connected with a 5G radio link to each other and/or to the main 5G core network.

A micro-net may be installed in an offshore or remote location and connect to other part of an electric power network or a process automation installation.

A micro-net with a radio link may enhance the basic functionalities to implement point-to-point radio link for normal connectivity, point-to-multipoint to implement network multicasting, e.g., at IP level, multiple point-to-point to generate redundancy radio links, repeater function to bridge communication of remote locations to the central control center or core network. At same time a micro-net may provide local coverage and routine 5G operations.

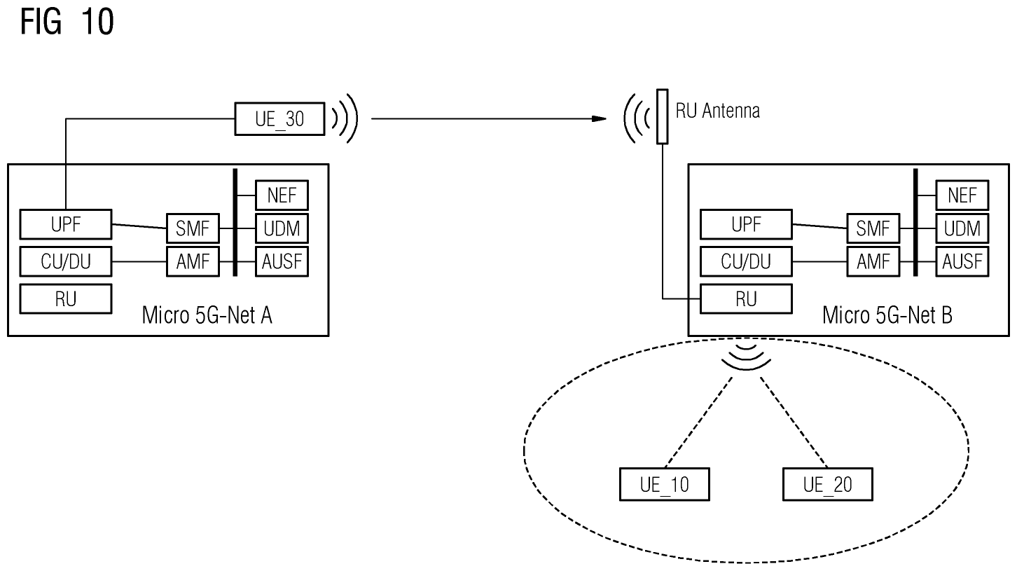

Turning to FIG. 10, a point to point radio link to interconnect more micro-nets is shown. Thereby connectivity may be provided by re-using part of the network equipment like Radio Units, RU, and User Equipment, UE.

A (dedicated) UE is connected to the local UPF or a router of micro-net A to transmit one or more packets, e.g., a data stream, to the other micro-net B. The subscription (e.g. SIM) of UE_30 belongs to the micro-net B and it is under the coverage of the RU installed in the micro-net B. The RU in micro-net B dedicates one TX/RX chain or a MIMO layer.

The UE_30 is under coverage of the micro-net B and transmits the packets coming from the local UPF of micro-net A to the RU of micro-net B. As described herein the UE_30 may be connected to the local UPF via a data network. The RU of micro-net B dedicates one MIMO layer or an RX/TX branch to communicate to UE_30. The local the UPF of the micro-net A, may include a routing table that identifies the UE_30 as the next hop and routes the one or more packets to it. UE_30 starts a communication with its own network, micro-net B, and sends the corresponding packets, or data in general. The receiver of the RU in micro-net B detects the signal, demodulates it, and sends it to the local UPF of the micro-net B. The local UPF of the micro-net B understands that the end destination address is UE_20 and routes the packet back to the RAN (CU/DU/RU) to the destination UE_20. The RAN will use the branches of the RU that provide local coverage.

Hence, a method of communicating with a first user equipment of a first micro-net, the method, by a second user plane function of a second micro-net, is provided. The method including: receiving, by a user plane function, one or more packets, e.g., from a second user equipment, associated with the second micro-net, wherein the one or more packets include a destination information associated with the first user equipment of the first micro-net. The method further including transmitting, by the second user plane function, the one or more packets to a first user plane function of the first micro-net, wherein the first user plane function is configured to transmit the one or more packets to the first user equipment of the first micro-net based on the destination information of the one or more packets. The method further including the second user plane function being communicatively connected to the first user plane function via a dedicated user equipment and radio unit. The dedicated user equipment being associated with the first micro-net. The radio unit being part of the first micro net, to which the dedicated user equipment is associated.

The one or more packets are transmitted from the second user plane function to the first user plane function via or over the air between the second dedicated user equipment and the radio unit. The dedicated user equipment being connected to the second micro-net and/or the second UPF via a data network. The data network being connected to the second UPF via a N6 interface. The data network being connected to the dedicated user equipment via the internet protocol. That is communication in and/or between entities in the data network may be performed at the internet protocol layer. The data network may provide operator services, internet access and/or 3rd party services. In general, the data network may include devices and/or the transmission media that allow data to be transmitted and received. The devices include computers, routers, switches, hubs, and servers, or a dedicated UE as provided herein. The transmission media may be copper wires, optical fibers, or wireless links. The devices are connected through a communication protocol, such as the internet protocol, IP, that allows the exchange of data between them. The user equipment may be connected to the data network via a wired connection for example, an ethernet connection and/or the internet protocol, e.g., using a static IP address.

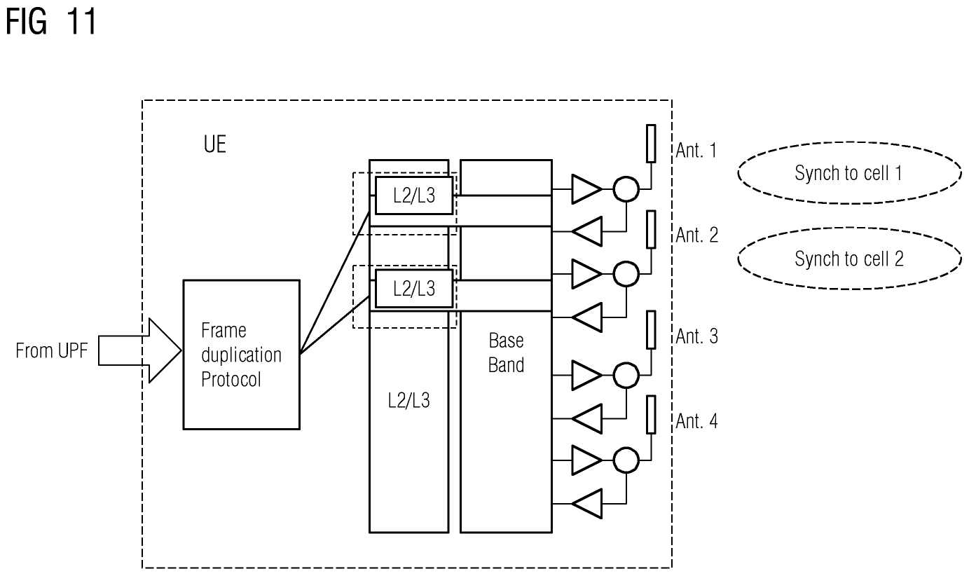

Turning to FIG. 11, as described herein, the dedicated UE, e.g., UE_30, may connect to two or multiple micro-nets to create radio redundancies paths, for example the dedicated UE, e.g., UE_30, may connect to two or multiple Micro-net to create radio redundancies paths. To achieve this the UE may implements one or more of the following functions: Each TX/RX layer may work independently from each other and is able to synchronize to different cells at the same time. One or more L2/L3 functions will be individual for each TX/RX path, like RACH channel transmission for accessing the network, retransmissions, as shown in FIG. 11. One or more L2/L3 functions might be common depending on the implementation. In the uplink transmission a frame duplication protocol function may be included. This will duplicate each (data) packet, e.g., of a data stream, to two different TX/RX path.

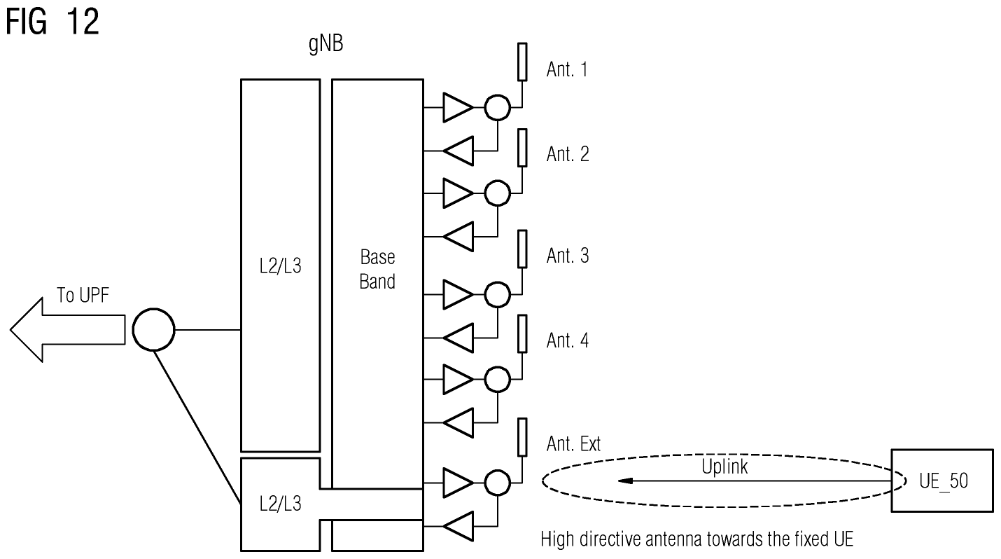

Turning to FIG. 12, correspondingly the radio units may dedicate one TX/RX layer for the uplink data transmission of a dedicated UE connected to another micro-net, as described herein. An RU may provide an extra TX/RX path dedicated to the Uplink of a dedicated UE, i.e. a UE connected to other micro-net. The received (data) packets are sent to the local UPF for further routing. In some cases, a complete RU with 4 MIMO layers or TX/RX chain may be dedicated as a collector of data coming from other four other micro-nets as shown in FIG. 12. Hence, a RU may provide or dedicate a TX/RX chain or MIMO Layer to a dedicated connection to another UE connected to another micro-net. A UE may use a single chain of the UE's TX/RX to take the packets from a micro-net and forward them to another micro-net. The UE may also include a frame replication protocol to map the same data stream on one or more radio links.

The present disclosure enables the connection via a, e.g., 5G, radio link of two or more micro-nets. Several topologies may be implemented: point-to-point, point to multi-point (e.g. multicast at network level), creation of redundancy paths, repeater and all in addition to local coverage.

It is to be understood that the elements and features recited in the appended claims may be combined in different ways to produce new claims that likewise fall within the scope of the present embodiments. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present embodiments have been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method of communicating with a first user equipment of a first micro-net, the method, by a second user plane function of a second micro-net, comprising:
receiving one or more packets from second user equipment associated with the second micro-net, wherein the one or more packets include a destination information associated with the first user equipment of the first micro-net; and
transmitting the one or more packets to a first user plane function of the first micro-net, wherein the first user plane function is configured to transmit the one or more packets to the first user equipment of the first micro-net based on the destination information of the one or more packets;
wherein the second user plane function is communicatively connected to the first user plane function via a first pair of first dedicated user equipment and first radio unit and a second pair of second dedicated user equipment and second radio unit, and
wherein the one or more packets are transmitted from the second user plane function to the first user plane function via air between the second dedicated user equipment from the second pair of second dedicated user equipment and second radio unit and the first radio unit from the first pair of first dedicated user equipment and first radio unit.

2. The method of claim 1, wherein the dedicated first user equipment is dedicated to the second user plane function and is for transmitting data to the first user plane function and wherein the dedicated second user equipment is dedicated to the first user plane function and is for transmitting data to the second user plane function.

3. The method of claim 1, wherein the second radio unit is dedicated to the second user plane function and is for receiving data from the first user plane function and wherein the first radio unit is dedicated to the first user plane function and is for receiving data from the second user plane function.

4. The method of claim 1, wherein the dedicated first user equipment is registered with the second user plane function and wherein the dedicated second user equipment is registered with the first user plane function.

5. The method of claim 1, wherein the first dedicated user equipment abstracts the second micro-net from the first user plane function and wherein the second dedicated user equipment abstracts the first micro-net from the second user plane function.

6. A network device for communicating with a first user equipment of a first micro-net, the network device comprising:
a first network interface connected to a second user equipment of a second micro-net;
a second network interface connected to at least one of a of second radio unit and a dedicated first user equipment; and
one or more processors connected to a memory module, the one or more processors configured to:
receive one or more packets from the second user equipment associated with the second micro-net via the first network interface, wherein the one or more packets include a destination information associated with the first user equipment of the first micro-net; and
transmit the one or more packets over the air to a first user plane function of the first micro-net via the dedicated first user equipment, wherein the first user plane function is configured to transmit the one or more packets to the first user equipment of the first micro-net based on the destination information of the one or more packets.

7. A non-transitory storage medium comprising a plurality of instructions, which when executed on one or more processors, cause the one or more processors to:
receive one or more packets from a second user equipment associated with a second micro-net via a first network interface, wherein the one or more packets include a destination information associated with a first user equipment of a first micro-net; and
transmit the one or more packets to a first user plane function of the first micro-net via a dedicated first user equipment, wherein the first user plane function is configured to transmit the one or more packets to the first user equipment of the first micro net based on the destination information of the one or more packets.
